(19) United States
(12) Patent Application Publication
(10) Pub. No.: US 2024/0055628 A1
(43) Pub. Date: Feb. 15, 2024

(54) Fuel Cell Exhaust Gas System

(71) Applicant: Purem GmbH, Neunkirchen (DE)

(72) Inventor: Gerd Gaiser, Reutlingen (DE)

(21) Appl. No.: 18/448,536

(22) Filed: Aug. 11, 2023

(30) Foreign Application Priority Data
Aug. 11, 2022 (DE) 10 2022 120 291.7

(51) Int. Cl. H01M 8/04119; H01M 8/04014; H01M 8/0662; H01M 8/04228

(52) U.S. Cl. CPC H01M 8/04164; H01M 8/04014; H01M 8/0662; H01M 8/04228; H01M 2008/1095

(57) ABSTRACT

A fuel cell exhaust gas system includes a first fuel cell exhaust gas cooler for accommodating a flow of fuel cell exhaust gas therethrough to dissipate heat from the fuel cell exhaust gas; and, a first separator separating condensate held in the fuel cell exhaust gas. The first separator is disposed near or downstream of the first fuel cell exhaust gas cooler. The system further includes a fuel cell exhaust gas heater for heating the fuel cell exhaust gas; and, the fuel cell exhaust gas heater is disposed near or downstream of the first separator.

### CROSS-REFERENCE TO RELATED APPLICATIONS

This application claims priority of German patent application no. 10 2022 120 291.7, filed Aug. 11, 2022, the entire content of which is incorporated herein by reference.

### TECHNICAL FIELD

The present disclosure relates to a fuel cell exhaust gas system, by way of which, for example in a vehicle, the fuel cell exhaust gas produced by a fuel cell operated for the generation of electrical energy can be discharged to the environment.

### BACKGROUND

In order to generate electrical energy in a fuel cell, hydrogen or a hydrogen-containing gas is supplied to an anode region of the fuel cell and oxygen or an oxygen-containing gas, for example air, is supplied to a cathode region of the fuel cell. A hydrogen-depleted gas is discharged as fuel cell exhaust gas at an anode exhaust gas outlet of the anode region of the fuel cell. An oxygen-depleted gas is discharged as fuel cell exhaust gas at a cathode exhaust gas outlet of the cathode region of the fuel cell. Depending on the type of fuel cell, primarily the fuel cell exhaust gas discharged at the cathode region of the fuel cell or primarily the fuel cell exhaust gas discharged at the anode region of the fuel cell contains a comparatively large proportion of water or water vapor. If fuel cell exhaust gas that is highly enriched with water vapor and has a relative humidity in the range of 90 to 100% is discharged to the environment by way of the fuel cell exhaust gas system, there is a risk, in particular at comparatively low ambient temperatures, that the temperature of the fuel cell exhaust gas will fall considerably on contact with the ambient air, which can lead to water condensing out of the fuel cell exhaust gas and thus to pronounced mist formation. Such mist formation can be perceived as objectionable and undesirable solely because of its visual appearance and, in particular at very low ambient temperatures, leads to the risk that, when the vehicle is stationary, ice will form on the ground beneath the vehicle in the region in which the fuel cell exhaust gas emerges into the environment.

### SUMMARY

It is an object of the present disclosure to provide a fuel cell exhaust gas system, in particular for a vehicle, with which mist formation in the fuel cell exhaust gas discharged to the environment can substantially be prevented.

According to the disclosure, this object is achieved by a fuel cell exhaust gas system, in particular fora vehicle, including:
a first fuel cell exhaust gas cooling unit through which fuel cell exhaust gas can flow and which is to dissipate heat from the fuel cell exhaust gas,
in the region or/and downstream of the first fuel cell exhaust gas cooling unit, a first separation unit for separating condensate contained in the fuel cell exhaust gas,
in the region or/and downstream of the first separation unit, a fuel cell exhaust gas heating unit for heating the fuel cell exhaust gas.

In the fuel cell exhaust gas system constructed in accordance with the disclosure, a portion of the water or water vapor transported in the fuel cell exhaust gas first precipitates out of the fuel cell exhaust gas as a result of the cooling of the fuel cell exhaust gas and the lowering of the temperature of the fuel cell exhaust gas to below the dew point and can be collected as condensate in particular in the first separation unit. Although the subsequent heating of the water- or water-vapor-depleted fuel cell exhaust gas in the fuel cell exhaust gas heating unit does not bring about any change in the amount of water vapor still contained in the fuel cell exhaust gas, the relative humidity in the fuel cell exhaust gas falls significantly as a result of the increase in temperature. If the water-vapor-depleted fuel cell exhaust gas is then discharged at the elevated temperature to the environment, spontaneous condensation or mist formation is avoided. Before its temperature falls significantly again, the fuel cell exhaust gas is able to mix to a sufficient degree with the ambient air so that, as a result of the dilution which thus occurs, pronounced local mist formation in the region in which the fuel cell exhaust gas leaves the fuel cell exhaust gas system can be avoided.

For efficient cooling of the fuel cell exhaust gas, the first fuel cell exhaust gas cooling unit can include a first heat exchanger for transferring heat from the fuel cell exhaust gas to a cooling medium, preferably a cooling liquid or cooling gas.

Likewise, for efficient heating of the water-vapor-depleted fuel cell exhaust gas, the fuel cell exhaust gas heating unit can include a second heat exchanger for transferring heat from a heating medium, preferably a heating liquid or heating gas, to the fuel cell exhaust gas, or/and at least one electrically excitable heater.

In order to be able to use the heat transported in the fuel cell exhaust gas for energy-efficient operation of a fuel cell system, it is proposed that a heat transfer medium which flows through the first heat exchanger and through the second heat exchanger provides the cooling medium and the heating medium. This heat transfer medium can thus transfer heat from the fuel cell exhaust gas flowing in a part of the fuel cell exhaust gas system that is located further upstream to the fuel cell exhaust gas flowing in a part of the fuel cell exhaust gas system that is located further downstream.

In an alternative embodiment variant which likewise utilizes the heat transported in the fuel cell exhaust gas, a heat exchanger unit which provides the first heat exchanger and the second heat exchanger can be provided, wherein the heat exchanger unit includes an upstream heat exchanger region through which the fuel cell exhaust gas can flow and, downstream of the upstream heat exchanger region, a downstream heat exchanger region which interacts with the upstream heat exchanger region for the transfer of heat. As a result of the interaction of the two heat exchanger regions for the transfer of heat, direct heat transfer which does not require a liquid or gaseous heat transfer medium and is thus very efficient is achieved.

In order to be able to dissipate the water that condenses out after cooling of the fuel cell exhaust gas also in the case of this substantially direct heat transfer, it is proposed that the first separation unit is arranged downstream of the upstream heat exchanger region and upstream of the downstream heat exchanger region.

For structural integration of various system regions of the fuel cell exhaust gas system and thus a compact construction, it is further proposed that a second fuel cell exhaust gas cooling unit for dissipating heat from the fuel cell exhaust gas is provided downstream of the upstream heat exchanger region or/and at a downstream end of the upstream heat exchanger region and upstream of the downstream heat exchanger region or/and at an upstream end of the downstream heat exchanger region. By providing such a second fuel cell exhaust gas cooling unit, the fuel cell exhaust gas, in addition to the cooling which already takes place in the upstream heat exchanger region, is further cooled upstream of the downstream heat exchanger region, and the condensing out of water is thus assisted.

The second fuel cell exhaust gas cooling unit can include a third heat exchanger for transferring heat from the fuel cell exhaust gas to a cooling medium, preferably a cooling liquid or cooling gas.

The heat exchanger unit can include a heat exchanger unit housing, wherein the upstream heat exchanger region and the downstream heat exchanger region are provided in the heat exchanger unit housing. The third heat exchanger can further be arranged substantially in the heat exchanger unit housing or/and the heat exchanger unit housing can be arranged so as to surround it on an outer side.

For efficient heat transfer for fuel cell exhaust gas flowing in different parts of the fuel cell exhaust gas system, the heat exchanger unit can include a countercurrent heat exchanger or a cross-flow heat exchanger.

For guiding fuel cell exhaust gas to the first fuel cell exhaust gas cooling unit, a first fuel cell exhaust gas line leading to the first fuel cell exhaust gas cooling unit can be provided. When water or water vapor is contained primarily in the cathode exhaust gas, the first fuel cell exhaust gas line can be a cathode exhaust gas line.

In order to separate water transported substantially in droplet form in the fuel cell exhaust gas even before the first fuel cell exhaust gas cooling unit, there can be associated with the first fuel cell exhaust gas line a second separation unit for separating liquid contained substantially in droplet form in the fuel cell exhaust gas.

The fuel cell exhaust gas system can further have a second fuel cell exhaust gas line, preferably an anode exhaust gas line, wherein the second fuel cell exhaust gas line merges into the first fuel cell exhaust gas line or into a fuel cell exhaust gas discharge line leading away from the fuel cell exhaust gas heating unit, which means that the two lines involved are brought together in order to combine the fuel cell exhaust gas streams guided therein. In particular when the second fuel cell exhaust gas line merges into the first fuel cell exhaust gas line, water or water vapor contained in the portion of the fuel cell exhaust gas that is guided through the second fuel cell exhaust gas line can also be separated.

In particular when the fuel cell exhaust gas guided through the second fuel cell exhaust gas line contains a relatively small proportion of water or water vapor, the second fuel cell exhaust gas line can merge into the first fuel cell exhaust gas line downstream of the second separation unit.

In order to prevent residual hydrogen that is still contained in the anode exhaust gas from being discharged to the environment in too high a concentration, there can be provided at least one oxidation unit, preferably a catalytic converter unit or/and burner, for oxidizing hydrogen contained in fuel cell exhaust gas discharged from a fuel cell.

When the second fuel cell exhaust gas line, that is, in particular the anode exhaust gas line, leads substantially directly into the fuel cell exhaust gas discharge line, at least one oxidation unit can be arranged in the second fuel cell exhaust gas line upstream of the point at which it merges into the fuel cell exhaust gas discharge line. In particular when the second fuel cell exhaust gas line merges into the first fuel cell exhaust gas line, at least one oxidation unit can be arranged in the first fuel cell exhaust gas line downstream of the point at which the second fuel cell exhaust gas line merges into the first fuel cell exhaust gas line.

In order to avoid as far as possible the emission of noise, generated, for example, by compressors or the like, of a fuel cell system by way of the fuel cell exhaust gas system, there can be provided at least one fuel cell exhaust gas silencer arranged in a fuel cell exhaust gas discharge line leading away from the fuel cell exhaust gas heating unit.

At least one fuel cell exhaust gas silencer is preferably arranged downstream of the point at which the second fuel cell exhaust gas line merges into the fuel cell exhaust gas discharge line, so that the transport of noise by way of the fuel cell exhaust gas flowing through the second fuel cell exhaust gas line can also be suppressed.

The disclosure relates further to a fuel cell system including a fuel cell and, associated with the fuel cell, a fuel cell exhaust gas system constructed in accordance with the disclosure.

In this fuel cell system, the first fuel cell exhaust gas line can be connected, preferably by way of a cathode exhaust gas shut-off unit, to a cathode exhaust gas outlet of the fuel cell, and the second fuel cell exhaust gas line can be connected, preferably by way of an anode exhaust gas shut-off unit, to an anode exhaust gas outlet of the fuel cell.

The disclosure relates further to a method for operating a fuel cell system, in particular a fuel cell system constructed in accordance with the disclosure, in which method fuel cell exhaust gas emitted by a fuel cell is cooled in order to condense out water, and the fuel cell exhaust gas depleted of water vapor after water has been condensed out is heated.

### BRIEF DESCRIPTION OF DRAWINGS

The invention will now be described with reference to the drawings wherein:

FIG. 1 shows a fuel cell system for a vehicle in a principle-based representation;

FIG. 2 shows a representation, corresponding to FIG. 1, of an alternative configuration of a fuel cell system;

FIG. 3 shows a further representation, corresponding to FIG. 1, of an alternative configuration of a fuel cell system;

FIG. 4 shows a further representation, corresponding to FIG. 1, of an alternative configuration of a fuel cell system;

FIG. 5 shows a further representation, corresponding to FIG. 1, of an alternative configuration of a fuel cell system;

FIG. 6 shows a further representation, corresponding to FIG. 1, of an alternative configuration of a fuel cell system;

FIG. 7 shows a further representation, corresponding to FIG. 1, of an alternative configuration of a fuel cell system; and,

FIG. 8 shows a further representation, corresponding to FIG. 1, of an alternative configuration of a fuel cell system.

### DETAILED DESCRIPTION

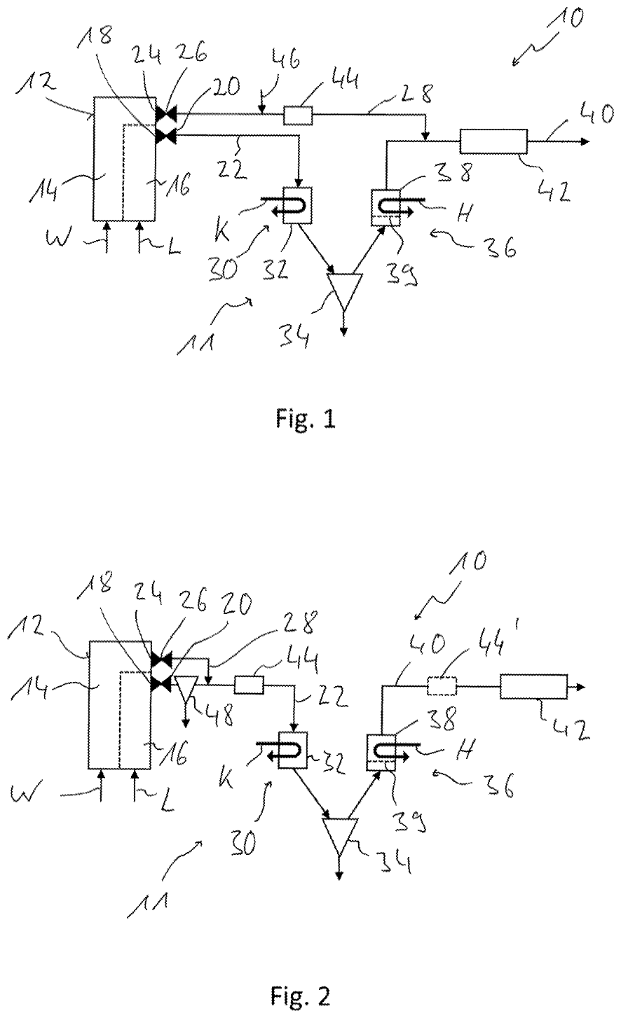

In FIG. 1, a fuel cell system for a vehicle is designated generally 10. The fuel cell system 10 includes a fuel cell 12, which in the example shown is in the form of, for example, a PEM fuel cell, having an anode region 14 and a cathode region 16. Hydrogen or hydrogen-containing gas W is supplied to the anode region 14. Oxygen or oxygen-containing and optionally also water-vapor-containing gas L, for example air, is supplied to the cathode region 16.

A first fuel cell exhaust gas line 22 of a fuel cell exhaust gas system 11 is connected by way of a cathode exhaust gas shut-off unit 20, for example a valve, regulating flap or the like, to a cathode exhaust gas outlet 18 of the fuel cell 12, wherein in the embodiment shown the first fuel cell exhaust gas line 22 is a cathode exhaust gas line. A second fuel cell exhaust gas line 28 of the fuel cell exhaust gas system 11 is connected by way of an anode exhaust gas shut-off unit 26 to an anode exhaust gas outlet 24 of the fuel cell, wherein in the embodiment shown the second fuel cell exhaust gas line 28 is an anode exhaust gas line.

The first fuel cell exhaust gas line 22 leads to a first fuel cell exhaust gas cooling unit 30. The first fuel cell exhaust gas cooling unit 30 can include a first heat exchanger 32, in which the fuel cell exhaust gas flowing through the first fuel cell exhaust gas line 22, that is, the cathode exhaust gas, transfers heat to a liquid or gaseous cooling medium K and is thereby cooled. As a result of this cooling, a portion of the water or water vapor contained in the cathode exhaust gas condenses out in a first separation unit 34 following the first fuel cell exhaust gas cooling unit 30 or can be collected in the first separation unit and, for example, fed back into the fuel cell process or discharged in liquid form to the environment.

In a fuel cell exhaust gas heating unit 36 following the first separation unit 34 downstream, the water-vapor-depleted fuel cell exhaust gas or cathode exhaust gas is heated again. This heating can take place in that heat is transferred by a heating medium H to the fuel cell exhaust gas flowing through the fuel cell exhaust gas heating unit 36, when the fuel cell exhaust gas heating unit 36 is in the form of a second heat exchanger 38. Alternatively or in addition, the fuel cell exhaust gas heating unit 36 can include an electrically excitable heater 39 through which the water-vapor-depleted fuel cell exhaust gas flows and which thereby transfers heat to the fuel cell exhaust gas.

The fuel cell exhaust gas which has been depleted of water vapor and heated again leaves the fuel cell exhaust gas heating unit 36 by way of a fuel cell exhaust gas discharge line 40, by way of which the cathode exhaust gas or fuel cell exhaust gas which has been depleted of water vapor and heated again is discharged to the environment.

In order that noise caused in the fuel cell system 10, for example by the operation of compressors or the like, is not conducted further to the environment by way of the fuel cell exhaust gas, a fuel cell exhaust gas silencer 42 can be provided in the fuel cell exhaust gas discharge line 40, which fuel cell exhaust gas silencer, for example as in the case of silencers associated with internal combustion engines, can include one or more chambers that are in communication with one another and through which the fuel cell exhaust gas can flow, or/and one or more resonator chambers.

The anode gas discharged as fuel cell exhaust gas by way of the anode exhaust gas outlet 24 generally still contains a residual amount of hydrogen. The concentration of hydrogen still contained in the anode exhaust gas may be so high that discharge to the environment is not permissible. There can therefore be arranged in the second fuel cell exhaust gas line 28 a catalytic converter unit 44 which forms an embodiment of an oxidation unit and in which the residual hydrogen contained in the anode exhaust gas is oxidized by oxygen supplied by way of a supply line 46. Air, for example, can be introduced into the second fuel cell exhaust gas line 28 by way of the supply line 46.

In the fuel cell system 10 shown in FIG. 1, a portion, in particular a relatively large portion, of the water vapor contained in the portion of the fuel cell exhaust gas that is emitted from the fuel cell 12 by way of the first fuel cell exhaust gas line 22, that is, the cathode exhaust gas, is first removed from that portion of the fuel cell exhaust gas by cooling. Because of its comparatively low temperature, the water-vapor-depleted fuel cell exhaust gas has a relatively high humidity, which can be close to 100%. By heating this fuel cell exhaust gas that is depleted of water vapor but nevertheless has a high relative humidity in the fuel cell exhaust gas heating unit 36, the relative humidity of the fuel cell exhaust gas is lowered, so that the fuel cell exhaust gas discharged to the environment by way of the fuel cell exhaust gas discharge line 40 has a relative humidity significantly below 100%. Even if this fuel cell exhaust gas discharged to the environment comes into contact with comparatively cold ambient air or with comparatively cold objects in the vicinity of a vehicle, spontaneous mist formation caused by water condensing out is avoided, because comparatively intensive mixing with ambient air and thus comparatively pronounced dilution of the fuel cell exhaust gas will take place before the temperature of the fuel cell exhaust gas discharged to the environment falls below the dew point.

An alternative embodiment of a fuel cell system 10 is shown in FIG. 2. The fuel cell system 10 of FIG. 2 has various modifications compared to the fuel cell system of FIG. 1, which can be provided individually or, as illustrated in FIG. 2, also in combination.

It can first be seen in FIG. 2 that the second fuel cell exhaust gas line 28 merges into the first fuel cell exhaust gas line 22. This means that the fuel cell exhaust gas discharged by way of the second fuel cell exhaust gas line 28, that is, the anode exhaust gas in the example shown, is also guided through the first fuel cell exhaust gas cooling unit 30 and the fuel cell exhaust gas heating unit 36. Thus, water contained in the anode exhaust gas, or water vapor contained therein, can also condense out or be collected at the first separation unit 34.

In order to oxidize residual hydrogen contained in the anode exhaust gas in this embodiment too, a catalytic converter unit 44 can be arranged in the first fuel cell exhaust gas line 22. Alternatively or in addition, a catalytic converter unit 44′ can be arranged in the fuel cell exhaust gas discharge line 40. The arrangement of the catalytic converter unit 44 upstream of the first fuel cell exhaust gas cooling unit 30 has the fundamental advantage that the fuel cell exhaust gas guided through the catalytic converter unit 44 has a comparatively high temperature, which contributes to efficient operation of the catalytic converter unit 44. The advantage of positioning the catalytic converter unit 44′ in the fuel cell exhaust gas discharge line is that the fuel cell exhaust gas flowing through the catalytic converter assembly 44′ contains a smaller proportion of water or water vapor, which contributes to reduced aging of the catalytic converter assembly 44′. The oxygen required for oxidizing the hydrogen can be provided by the residual oxygen contained in the cathode exhaust gas, so that an additional introduction of oxygen or air is not required.

It can further be seen in FIG. 2 that a second separation unit 48 is arranged in the first fuel cell exhaust gas line 22, for example upstream with respect to the catalytic converter assembly 44. In the embodiment shown, a portion of the water carried in particular in droplet form with the cathode exhaust gas can already be removed from the cathode exhaust gas via the second separation unit 48, so that the fuel cell exhaust gas flowing through the catalytic converter unit 44 positioned upstream of the first fuel cell exhaust gas cooling unit 30 and of the first separation unit 34 already contains a reduced proportion of water or water vapor.

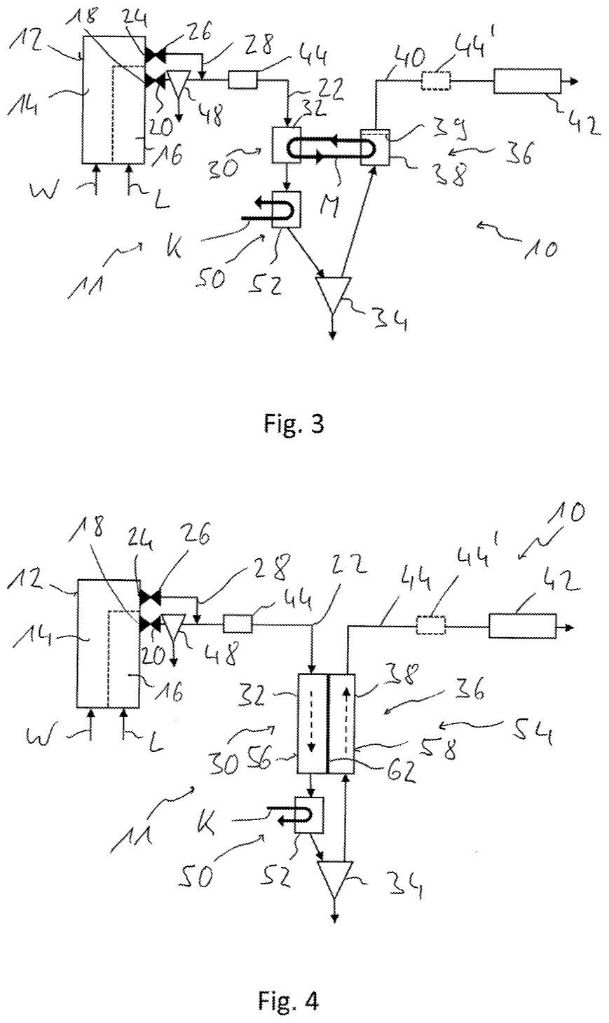

An embodiment of the fuel cell system 10 that is modified in particular in the region of the first fuel cell exhaust gas cooling unit 30 and of the fuel cell exhaust gas heating unit 36 is illustrated in FIG. 3. In this embodiment, heat is removed from the fuel cell exhaust gas flowing through the first fuel cell exhaust gas cooling unit 30 in the form of a first heat exchanger 32 via a heat transfer medium M, which is guided in a circuit, for example in a closed circuit, also through the fuel cell exhaust gas heating unit 36 in the form of a second heat exchanger 38. Thus, the fuel cell exhaust gas flowing further downstream in the fuel cell exhaust gas system 11 can be heated via the fuel cell exhaust gas flowing further upstream in the fuel cell exhaust gas system 11. Alternatively or in addition, the fuel cell exhaust gas flowing through the fuel cell exhaust gas heating unit 36 can be heated therein by a heating medium H or/and an electrically excitable heater 39.

In order to be able to cool the fuel cell exhaust gas further, a second fuel cell exhaust gas cooling unit 50 is arranged downstream of the first fuel cell exhaust gas cooling unit 30. The second fuel cell exhaust gas cooling unit can include, for example, a third heat exchanger 52, in which the fuel cell exhaust gas already cooled in the first fuel cell exhaust gas cooling unit 30 can transfer heat to the cooling medium K. Thus, as already described hereinbefore, water condenses out in the first separation unit 34, so that water-vapor-depleted fuel cell exhaust gas flows in the direction toward the fuel cell exhaust gas heating unit 36 following downstream.

A variant that is advantageous especially in terms of efficient heat transfer and a simple structural configuration, in which the heat contained in the fuel cell exhaust gas is similarly used to heat a portion of the fuel cell exhaust gas flowing further downstream, is shown in FIG. 4. In the embodiment shown in FIG. 4 of the fuel cell exhaust gas system 11 there is provided a heat exchanger unit, designated generally 54, which in the embodiment shown is in the form of a countercurrent heat exchanger. The heat exchanger unit 54 includes an upstream heat exchanger region 56 which provides the first fuel cell exhaust gas cooling unit 30, or the first heat exchanger 32.

The heat exchanger unit 54 further includes a downstream heat exchanger region 58 which provides the fuel cell exhaust gas heating unit 36, or the second heat exchanger 38. The two heat exchanger regions 56, 58 can be formed in the manner of channels in a heat exchanger unit housing 60 of the heat exchanger unit 54 and provide flow channels which are separated from one another by one or more partition walls 62 and in which the fuel cell exhaust gas flows substantially in mutually opposite directions and thereby transfers heat from the portion of the fuel cell exhaust gas flowing through the upstream heat exchanger region 56 to the portion of the fuel cell exhaust gas flowing through the downstream heat exchanger region 58.

It should be noted that, in this embodiment too, the fuel cell exhaust gas flowing in the fuel cell exhaust gas heating unit 36, that is, in the downstream heat exchanger region 58, can additionally be heated by a heating medium or/and an electrically excitable heater, as described hereinbefore.

The fuel cell exhaust gas flowing through and leaving the upstream heat exchanger region 56 is guided to the second fuel cell exhaust gas heating unit 50, or to the third heat exchanger 52, following the upstream heat exchanger region 56 downstream, where it delivers heat to the cooling medium K and is thus cooled further. The water that condenses out of the fuel cell exhaust gas as a result of the further cooling is collected in the first separation unit 34. The water-vapor-depleted fuel cell exhaust gas then flows further to the downstream heat exchanger region 58, where it is heated by thermal interaction with the fuel cell exhaust gas flowing in the downstream heat exchanger region 58 and optionally additionally by a heating medium or/and an electrically excitable heater.

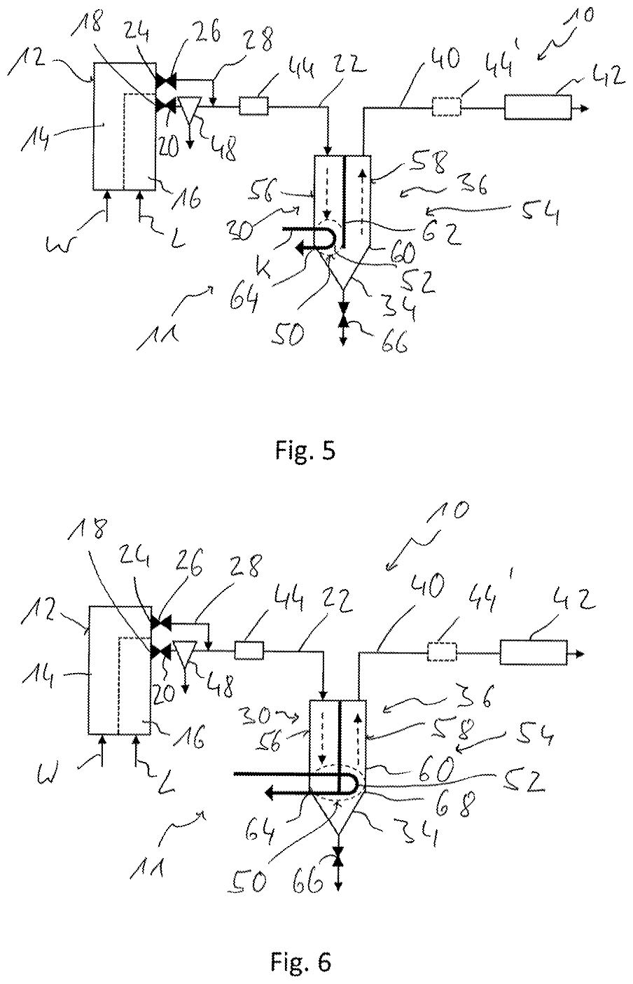

FIG. 5 shows an embodiment variant in which the second fuel cell exhaust gas cooling unit 50 and the first separation unit 34 are structurally combined with the heat exchanger unit 54. As can be seen in FIG. 5, the third heat exchanger 52 of the second fuel cell exhaust gas cooling unit 50 can be integrated into the upstream heat exchanger region 56, in particular into a downstream end 64 thereof. At or after this downstream end 64 of the upstream heat exchanger region 56, there is a fluidic transition to the first separator unit 34 and, from there, to the downstream heat exchanger region 58. Water collected at the first separation unit 34 and thus also in the heat exchanger unit housing 60 of the heat exchanger unit 54 can, for example, be discharged to the environment by way of a shut-off unit 66 or fed back into the fuel cell process.

For very efficient heat transfer, the third heat exchanger 52 can have fins, which increase the available surface area for thermal interaction with the fuel cell exhaust gas flowing in the upstream heat exchanger region 56.

In the modification shown in FIG. 6 of the structural principle illustrated in FIG. 5, the second fuel cell exhaust gas cooling unit 50 is integrated both into the upstream heat exchanger region 56, in particular in the region of the downstream end 64 thereof, and in the downstream heat exchanger region 58, in particular an upstream end 68 thereof. Thus, water or water vapor can be condensed out in the entire transition region from the upstream heat exchanger region 56, that is, the first fuel cell exhaust gas cooling unit 30, to the downstream heat exchanger region 58, that is, the fuel cell exhaust gas heating unit 36, by cooling of the fuel cell exhaust gas and can be received or collected in the first separation unit 34.

In this embodiment too, for very efficient heat transfer, the third heat exchanger 52 can have fins which increase the available surface area for thermal interaction with the fuel cell exhaust gas flowing in the upstream heat exchanger region 56. It should further be noted that, in this embodiment too, additional heating of the fuel cell exhaust gas flowing through the downstream heat exchanger region 58 can take place via a heating medium or/and an electrically excitable heater.

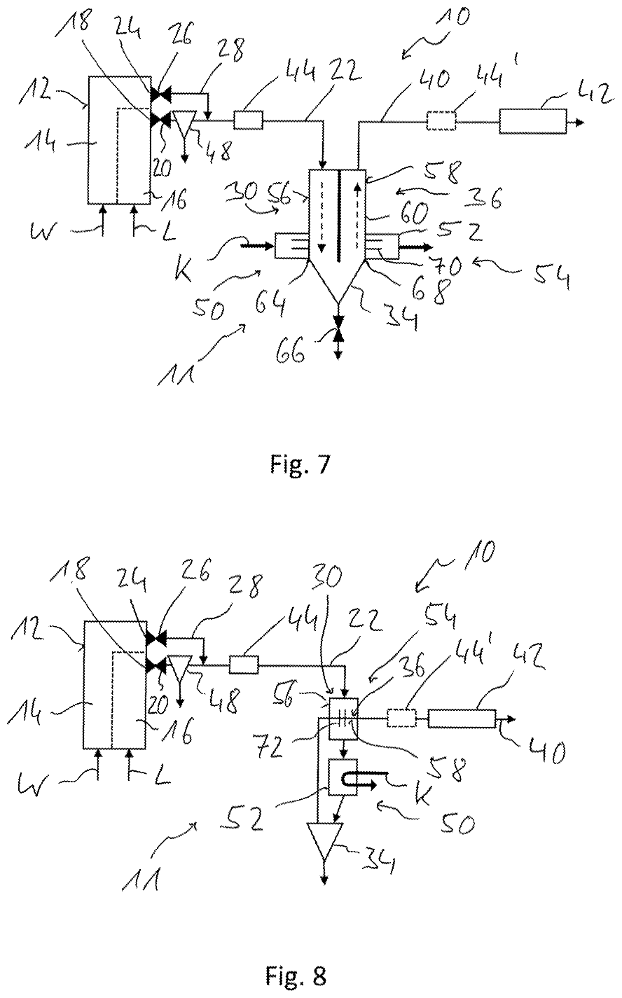

In the embodiment variant of a fuel cell exhaust gas system 11 shown in FIG. 7 too, heat is removed from the fuel cell exhaust gas at the heat exchanger unit 54 in the region of the downstream end 64 of the upstream heat exchanger region 56 and in the region of the upstream end 66 of the downstream heat exchanger region 58. For this purpose, the heat exchanger housing 60 of the heat exchanger unit 54 surrounds the first heat exchanger 32 of the first fuel cell exhaust gas cooling unit 30 on its outer side and can be flowed through by the cooling medium K. For enhanced thermal interaction and thus for improved heat dissipation from the fuel cell exhaust gas flowing through the heat exchanger unit 54, heat transfer fins 70 can be provided on the outer side of the heat exchanger unit housing 60, via which the available surface area for the delivery of heat to the cooling medium K is increased.

A further alternative embodiment, in which heat can be transferred in a heat exchanger unit 54 from the fuel cell exhaust gas flowing in a part of the fuel cell exhaust gas system 11 that is located further upstream to the fuel cell exhaust gas flowing in a part of the fuel cell exhaust gas system 11 that is located further downstream, is illustrated in FIG. 8. In this embodiment, the heat exchanger unit 54 is in the form of a cross-flow heat exchanger. In the heat exchanger unit housing 60 there is formed a volume which substantially provides the upstream heat exchanger region 56 and through which the fuel cell exhaust gas supplied by way of the first fuel cell exhaust gas line 22 flows. The fuel cell exhaust gas guided through this upstream heat exchanger region 56 then flows through the second fuel cell exhaust gas cooling unit 50, or through the third heat exchanger 52 thereof, and thereby delivers heat to the cooling medium K. After it has flowed through the first separation unit 34, the water-vapor-depleted fuel cell exhaust gas then flows through a line region which provides the downstream heat exchanger region 58 and runs in the heat exchanger unit housing 60 and on which heat transfer fins 72 for enhanced thermal interaction with the fuel cell exhaust gas flowing through the upstream heat exchanger region 56 can be provided.

In this embodiment too, the fuel cell exhaust gas leaves the upstream heat exchanger region 56, or the heat exchanger unit 54, in heated form and then flows, for example, to the catalytic converter unit 44′ and the silencer 42 before it is heated and thus discharged to the environment with a comparatively low relative humidity.

In the embodiments shown in FIGS. 7 and 8 too, the measures described hereinbefore can additionally be associated with the downstream heat exchanger region 58 for additional heating. Thus, the water-vapor-depleted fuel cell exhaust gas flowing through the downstream heat exchanger region 58 can additionally be heated by a heating medium or/and an electrically excitable heater.

In all the embodiments described hereinbefore, the cooling medium K or/and the heating medium H, where used, can be provided by liquids or gases, wherein in particular the cooling medium K can deliver the heat taken up therein in a further heat exchanger to the environment. The cooling medium K can, for example, also be provided by the ambient air, so that the first heat exchanger, for example, can include a plurality of fins around which ambient air can flow. The heating medium H can, for example, be heated in the catalytic oxidation process which takes place in the catalytic converter unit 44 or 44′. Alternatively, instead of such a catalytic converter unit or in addition to the catalytic converter unit for oxidizing the residual hydrogen still contained in the anode exhaust gas, there can be provided as a further example of an oxidation unit a burner in which the residual hydrogen is burned with oxygen, for example the residual oxygen contained in the cathode exhaust gas. The heat thereby formed can be transferred in a heat exchanger associated with the burner to the heating medium H and from there to the fuel cell exhaust gas flowing through the second heat exchanger 38.

In a fuel cell exhaust gas system constructed in accordance with the disclosure, it is possible, as is illustrated in particular by the embodiments of FIGS. 4 to 7, to provide a structural connection or fusion of different system regions, in particular of the first fuel cell exhaust gas cooling unit, the first separation unit and the fuel cell exhaust gas heating unit, optionally also with the second fuel cell exhaust gas cooling unit, so that these various system regions adjoin one another directly or also overlap fluidically. Thus, via the first separation unit, water vapor or water can already be separated from the fuel cell exhaust gas in the region of the first fuel cell exhaust gas cooling unit or/and also in the region of the fuel cell exhaust gas heating unit and can be collected, for example, in liquid form.

It should be noted that the construction described hereinbefore of a fuel cell exhaust gas system can also be used in fuel cells that operate by other functional principles, in which a relatively large proportion of water or water vapor also or alternatively forms in the anode region and is discharged from the fuel cell by way of the anode exhaust gas. In such a case, the first fuel cell exhaust gas line, for example, could be connected to the anode exhaust gas outlet of the fuel cell, while the second fuel cell exhaust gas line could be connected to the cathode exhaust gas outlet of the fuel cell.

It is understood that the foregoing description is that of the preferred embodiments of the invention and that various changes and modifications may be made thereto without departing from the spirit and scope of the invention as defined in the appended claims.

1. A fuel cell exhaust gas system comprising:
a first fuel cell exhaust gas cooler for accommodating a flow of fuel cell exhaust gas therethrough to dissipate heat from the fuel cell exhaust gas;
a first separator separating condensate held in said fuel cell exhaust gas;
said first separator being disposed near and/or downstream of said first fuel cell exhaust gas cooler;
a fuel cell exhaust gas heater for heating the fuel cell exhaust gas; and,
said fuel cell exhaust gas heater being disposed near and/or downstream of said first separator.

2. The fuel cell exhaust gas system of claim 1, wherein said first fuel cell exhaust gas cooler comprises: a first heat exchanger for transferring heat from said fuel cell exhaust gas to a cooling medium.

3. The fuel cell exhaust gas system of claim 2, wherein said cooling medium is a cooling liquid or a cooling gas.

4. The fuel cell exhaust gas system of claim 2, wherein at least one of the following applies:
i) said fuel cell exhaust gas heater comprises a second heat exchanger for transferring heat from a heating medium to said fuel cell exhaust gas; and,
ii) said fuel cell exhaust gas heater comprises at least one electrically excitable heater.

5. The fuel cell exhaust gas system of claim 4, wherein said heating medium is a heating liquid or heating gas.

6. The fuel cell exhaust gas system of claim 4, wherein said first and second heat exchangers are configured to pass a heat transfer medium therethrough to provide said cooling medium and said heating medium.

7. The fuel cell exhaust gas system of claim 4, further comprising a composite heat exchanger for defining said first and second heat exchangers; and, said composite heat exchanger comprises an upstream heat exchanger region through which said fuel cell exhaust gas can flow and, downstream of said upstream heat exchanger region, a downstream heat exchanger region interacting with said upstream heat exchanger region for transferring heat.

8. The fuel cell exhaust gas system of claim 7, wherein said first separator is arranged downstream of said upstream heat exchanger region and upstream of said downstream heat exchanger region.

9. The fuel cell exhaust gas system of claim 7, wherein a second fuel cell exhaust gas cooler for dissipating heat from said fuel cell exhaust gas is provided at least at one of the following locations:
i) downstream of said upstream heat exchanger region; and,
ii) at a downstream end of said upstream heat exchanger region and upstream of said downstream heat exchanger region; and,
iii) at an upstream end of said downstream heat exchanger region.

10. The fuel cell exhaust gas system of claim 9, wherein said second fuel cell exhaust gas cooler comprises: a third heat exchanger for transferring heat from said fuel cell exhaust gas to said cooling medium including a cooling liquid or cooling gas.

11. The fuel cell exhaust gas system of claim 10, wherein said third heat exchanger comprises:
a heat exchanger housing;
said upstream heat exchanger region and said downstream heat exchanger region being provided in said heat exchanger housing; and,
said third heat exchanger being arranged in said heat exchanger housing and/or said heat exchanger housing being arranged so as to surround said third heat exchanger on an outer side thereof.

12. The fuel cell exhaust gas system of claim 7, wherein said composite heat exchanger unit comprises a countercurrent heat exchanger or a cross-flow heat exchanger.

13. The fuel cell exhaust gas system of claim 1, further comprising a first fuel cell exhaust gas line leading to said first fuel cell exhaust gas cooler.

14. The fuel cell exhaust gas system of claim 13, wherein said first fuel cell exhaust gas line is a cathode exhaust gas line.

15. The fuel cell exhaust gas system of claim 13, further comprising: a second separator associated with said first fuel cell exhaust gas line and said second separator being configured for separating liquid contained in droplet form in said fuel cell exhaust gas.

16. The fuel cell exhaust gas system of claim 15, further comprising a fuel cell exhaust gas discharge line leading away from said fuel cell exhaust gas heater; and, a second fuel cell exhaust gas line merging into said first fuel cell exhaust gas line or into said fuel cell exhaust gas discharge line.

17. The fuel cell exhaust gas system of claim 16, wherein said second fuel cell exhaust gas line merges into said first fuel exhaust gas line downstream of said second separator.

18. The fuel cell exhaust gas system of claim 16, further comprising at least one oxidation unit and/or burner for oxidizing hydrogen contained in said fuel cell exhaust gas.

19. The fuel cell exhaust gas system of claim 18, wherein said oxidation unit is a catalytic converter.

20. The fuel cell exhaust gas system of claim 18, further comprising at least one of the following:
i) said at least one oxidation unit arranged in said second fuel cell exhaust gas line upstream of a point whereat said second fuel cell exhaust gas line merges into said fuel cell exhaust gas discharge line; and,
ii) at least one oxidation unit arranged in said first fuel cell exhaust gas line downstream of a point whereat said second fuel cell exhaust gas line merges into said first fuel cell exhaust gas line.

21. The fuel cell exhaust gas system of claim 16, further comprising at least one fuel cell exhaust gas silencer arranged in a fuel cell exhaust gas discharge line leading away from said fuel cell exhaust gas heater.

22. The fuel cell exhaust gas system of claim 21, wherein said at least one fuel cell exhaust gas silencer is arranged downstream of a point whereat said second fuel cell exhaust gas line merges into said fuel cell exhaust gas discharge line.

23. A fuel cell system comprising:
a fuel cell; and,
a fuel cell exhaust gas system including:
a first fuel cell exhaust gas cooler for accommodating a flow of fuel cell exhaust gas therethrough to dissipate heat from the fuel cell exhaust gas;
a first separator separating condensate held in said fuel cell exhaust gas;
said first separator being disposed near and/or downstream of said first fuel cell exhaust gas cooler;
a fuel cell exhaust gas heater for heating the fuel cell exhaust gas; and,
said fuel cell exhaust gas heater being disposed near and/or downstream of said first separator.

24. The fuel cell system of claim 23, further comprising:
a fuel cell having an anode exhaust gas shut-off unit and a cathode exhaust gas shut-off unit;
said fuel cell further having an anode exhaust gas outlet and a cathode exhaust gas outlet;
a first fuel cell exhaust gas line being connected via said cathode exhaust gas shut-off unit to said cathode exhaust gas outlet; and,
a second fuel cell exhaust gas line being connected via said anode exhaust gas shut-off unit to said anode exhaust gas outlet.

25. A method for operating a fuel cell system including: a fuel cell; and, a fuel cell exhaust gas system including: a first fuel cell exhaust gas cooler for accommodating a flow of fuel cell exhaust gas therethrough to dissipate heat from the fuel cell exhaust gas; a first separator separating condensate held in said fuel cell exhaust gas; said first separator being disposed near and/or downstream of said first fuel cell exhaust gas cooler; a fuel cell exhaust gas heater for heating the fuel cell exhaust gas; and, said fuel cell exhaust gas heater being disposed near and/or downstream of said first separator, the method comprising the steps of:
cooling the fuel cell exhaust gas emitted by the fuel cell to condense out water; and,
heating the fuel cell exhaust gas depleted of water vapor after water has been condensed out.
